(19) United States
(12) Patent Application Publication
(10) Pub. No.: US 2013/0157234 A1
(43) Pub. Date: Jun. 20, 2013

(54) STORYLINE VISUALIZATION

(71) Applicants: Antonino Gulli, London (GB); Antonio Savona, London (GB); Giovanni Deretta, London (GB); Daniel Bernhardt, London (GB)

(72) Inventors: Antonino Gulli, London (GB); Antonio Savona, London (GB); Giovanni Deretta, London (GB); Daniel Bernhardt, London (GB)

(73) Assignee: Microsoft Corporation, Redmond, WA (US)

(21) Appl. No.: 13/325,365

(22) Filed: Dec. 14, 2011

(51) Int. Cl. G09B 19/00

(52) U.S. Cl. 434/154

(57) ABSTRACT

One or more techniques and/or systems are disclosed for constructing a storyline visualization. The storyline visualization may be constructed from one or more temporal documents (e.g., news stories having publication dates). The temporal documents may be organized into chapters, subchapters, and/or various storylines interconnected by branches. In this way, the storyline visualization may relate to a main story, which may branch into various storylines that respectively comprise one or more chapters. A user may be able to interactively explore the storyline visualization to understand the evolution of the main story (e.g., how a first storyline may have developed and/or be related to a second (developing) storyline). The storyline visualization may provide access to the underlying temporal documents. The storyline visualization may be presented as a timeline, a virtual storybook, a photo album, and/or other various visualizations.

### BACKGROUND

Many users create, share, and/or consume information over the internet. In one example, users may share their opinions through blogs. In another example, a news corporation may publish news articles through a news website. In another example, users may share ideas as social network posts and/or upload photos through a social networking website. In this way, an overwhelming amount of content is available through the internet (e.g., a social network may comprise millions of users that may share ideas/opinions on a daily basis). Searching tools, such as a web search engine, may allow users to submit search queries to locate desirable content (e.g., in response to a user submitting a query “Japan earthquake”, a web search engine may provide query results comprising web pages and/or images relevant to an earthquake in Japan). Such searching tools may present content in various ways. Unfortunately, conventional manners within which content may be presented may not illustrate the evolution of a main story, storylines discussed by news stories, and/or other information accumulated over time. Thus, a user may be left to sift through an overwhelming amount of information.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for creating a storyline visualization are disclosed herein. The storyline visualization may be created using temporal documents, such as news articles, web pages, social network posts, blogs, microblogs, documents, and/or other temporal data (e.g., data, documents, etc. associated with timestamps corresponding to a publication date, a creation date, a modification date, a crawl date, etc.). The storyline visualization may illustrate a main story and/or various storylines derived from the main story by organizing temporal documents into chapters, subchapters, and/or branches to additional storylines (e.g., cluster analysis techniques may be used to cluster temporal documents, assign document topics to temporal documents, identify chapters, and/or assign chapter topics to chapters). The storyline visualization may represent a main story (e.g., an earthquake in Japan). The main story may be represented by one or more storylines (e.g., a first storyline may correspond to rescue efforts, a second storyline may correspond to survivor stories, a third storyline may correspond to reactions by foreign nations, etc.). A storyline may comprise one or more chapters indicative of the storyline. A chapter may comprise a grouping of temporal documents comprising similar document topics and/or similar timestamps (e.g., one or more news stories comprising document topics regarding rescue efforts associated with an earthquake in Japan and timestamps specifying publication dates between 4/23 and 4/25). That is, the chapter may comprise content similar and/or temporally similar documents. The chapter may be assigned a chapter topic based upon temporal documents assigned to the chapter (e.g., a rescue efforts chapter topic may be assigned to a chapter based upon temporal documents relating to rescue efforts associated with the Japan earthquake being assigned to the chapter).

A subchapter may be created for a chapter based upon one or more new temporal documents that are indicative of an additional aspect of the chapter (e.g., a chapter may represent rescue efforts, while a new temporal document may describe how a 5 year old child was rescued from the rubble). In this way, the subchapter describing the additional aspect of the chapter may be assigned to the chapter, and the one or more new temporal documents may be assigned to the subchapter.

A branch from a chapter within a first storyline to a second chapter within a second storyline may be created (e.g., both under the main story) based upon one or more temporal documents associated with the main story that are not associated with the first storyline, but are instead associated with the second storyline (e.g., a branch may be created from a chapter within a first storyline relating to earth quake rescue efforts to a second storyline based upon a news story regarding foreign nations speaking about the economic impact of the Japan earthquake). In one example, the one or more temporal documents used to create the branch may be used to identify/define the second storyline and/or the second chapter within the second storyline (e.g., such temporal documents may be assigned to the second chapter).

In this way, the storyline visualization may be created based upon organizing the temporal documents into chapters, subchapters, and/or branches between various storylines. The storyline visualization may illustrate the organized temporal documents in a variety of ways, such as a virtual storybook, a timeline, a photo album, a slideshow, a tree structure, and/or various other illustrative visualizations. The storyline visualization may be presented to a user that may be searching for temporal documents. For example, a user may submit a “Japan earthquake” search query to a news aggregation service. Instead of merely returning a histogram illustrating news stories organized into particular days, the storyline visualization may be created and/or presented to the user so that the user may interactively explore the evolution of the main story and/or various storylines related to the Japan earthquake. In another example of presenting the storyline visualization, the storyline visualization may be presented to a user in a browse scenario (e.g., merely based upon the user browsing information, which may or may not involve a search by the user). In one example, the user may choose to learn more about a particular story (e.g., an option may be provided to the user to explore a story that the user is reading). In another example, the user's interest in a story may be inferred implicitly through other means (e.g. one or more preferences of the user, prior interactions by the user with information, browsing history of the user, etc.).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of creating a storyline visualization.

FIG. 2 is a flow chart illustrating an exemplary method of creating a storyline visualization.

FIG. 3 is a component block diagram illustrating an exemplary system for creating a storyline visualization.

FIG. 4 is an illustration of an example of a storyline visualization.

FIG. 5 is an illustration of an example of creating a chapter for a storyline visualization.

FIG. 6 is an illustration of an example of a storyline visualization.

FIG. 7 is an illustration of an example of creating a branch for a storyline visualization.

FIG. 8 is an illustration of an example of a storyline visualization comprising a branch from a first storyline to a second storyline.

FIG. 9A is an illustration of an example of a storyline visualization implemented as a virtual storybook.

FIG. 9B is an illustration of an example of a storyline visualization implemented as a photo album.

FIG. 10 is an illustration of an exemplary computer-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing subject matter.

Today, users create, organize, share, search, and/or interact with temporal documents, such as news stories, blogs, and/or other data associated with timestamps. In one example, a user may browser photos uploaded to a photo sharing website by other users, where such photos may be associated with upload dates. In another example, a user may search for news articles from a news aggregation service, where such news articles may be associated with creation dates, publication dates, etc. Temporal documents may be presented to users in a variety of ways. In one example, if a user submits a search query, then query results comprising temporal documents may be presented based upon relevance of the temporal documents to the search query. Unfortunately, current visualizations for temporal documents may comprise a vast amount of temporal documents that may be merely organized based upon dates, such that a user may have to shift through a large number of temporal documents (e.g., various news stories published on a particular day may discuss different storylines of the main story). Because the organization is merely based upon dates, the user may be unable to track the evolution of a main story represented by the temporal documents (e.g., the user may be overwhelmed by the amount of information and/or lack of structure).

Accordingly, among other things, one or more systems and/or techniques for creating a storyline visualization are provided herein. The storyline visualization may represent a main story and/or one or more storylines derived from the main story. That is, the storyline visualization may organize temporal documents associated with the main story into chapters, subchapters, and/or branches between storylines. In this way, a user may visualize and/or explore the evolution of the main story over time (e.g., how the main story may have branched into various storylines).

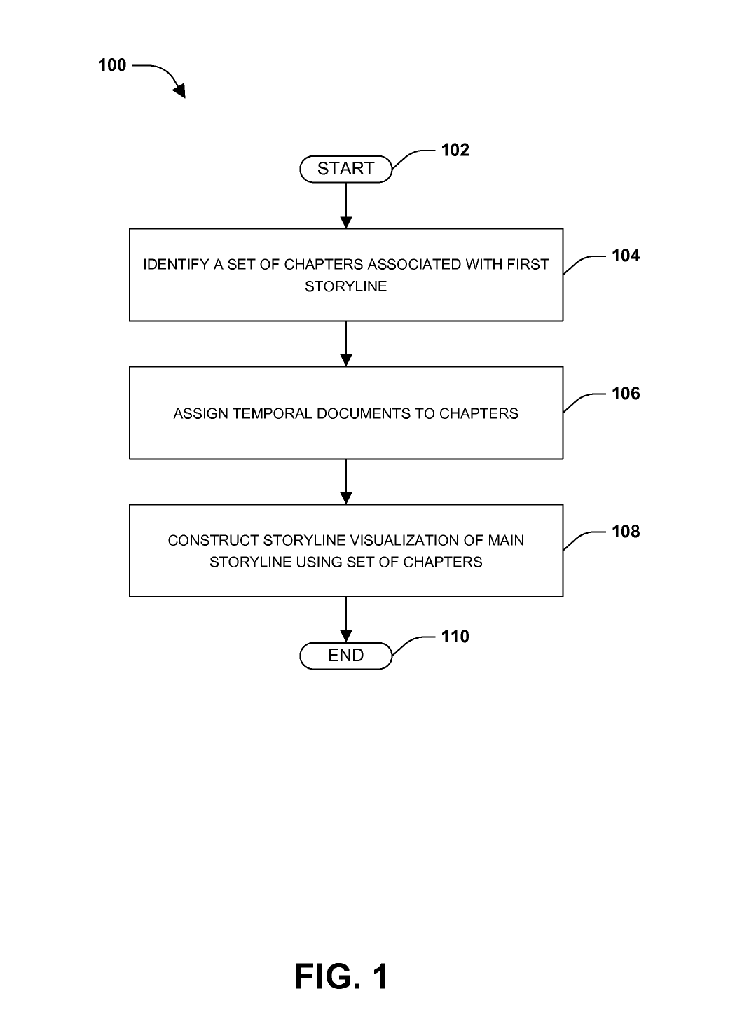

One embodiment of creating a storyline visualization is illustrated by an exemplary method 100 in FIG. 1. The storyline visualization may relate to a main story extracted from various temporal documents (e.g., data associated with a timestamp, such as news stories, blogs, social network posts, web pages, etc.). The temporal documents may comprise documents topics describing content of the temporal documents. For example, a cluster analysis technique may have been performed upon temporal documents to assign document topics to temporal documents and/or group similar temporal documents into clusters. It may be appreciated that the cluster analysis technique may correspond to a variety of grouping and/or organizing techniques, and is not limited to merely a clustering algorithm. In this way, the temporal documents may be evaluated based upon document topics, clusters, and/or timestamps to identify groupings of content similar and/or temporally similar temporal documents that may be indicative of chapters of the main story discussed within such temporal documents (e.g., news articles relating to similar news topics that were published within a relatively short time span of one another).

At 102, the method starts. At 104, a set of chapters (e.g., one or more chapters) associated with a first storyline of a main story may be identified. The set of chapters may, for example, be identified based upon a cluster analysis of temporal documents. For example, content similar and/or temporally similar temporal documents (e.g., temporal documents assigned to a cluster) may be indicative of a chapter (e.g., news stories discussing rescue efforts of an earthquake in Japan that were published between 4/23 and 4/25 may be used to create a chapter regarding rescue efforts within a first storyline regarding the Japan earthquake). Upon identifying a chapter within the set of chapters, a chapter topic may be assigned to the chapter based upon document topics of temporal documents indicative of the chapter (e.g., document topics associated with the news stories discussing the rescue efforts may be used to assign a chapter topic to the chapter regarding rescue efforts). A date range may be assigned to the chapter based upon timestamps of the temporal documents indicative of the chapter (e.g., a date range of 4/23 to 4/25 may be assigned to the chapter). In this way, the set of chapters associated with the first storyline may be created, where a chapter within the set of chapters may be assigned a chapter topic and/or a date range.

At 106, respective temporal documents may be assigned to chapters within the set of chapters. In one example, a current temporal document may be assigned to a current chapter based upon a document topic of the current temporal document corresponding to (e.g., being content similar to) a current chapter topic of the current chapter (e.g., the current temporal document may comprise content, as indicated by the document topic, similar to the current chapter topic of the chapter). In another example, the current temporal document may be assigned to the current chapter based upon a timestamp of the current temporal document corresponding to (e.g., being temporally similar to) a date range of the current chapter. In this way, temporal documents that are content similar and/or temporally similar to a chapter may be assigned to the chapter.

At 108, a storyline visualization of the main story may be constructed using the set of chapters. The storyline visualization may comprise various types of visualizations, such as a timeline, a virtual story book, a photo album, a slideshow, a tree structure, etc. Because additional aspects of a chapter may lead to subchapters and/or the main story may branch into other storylines, subchapters and/or branches to other storylines may be created within the storyline visualization. In one example, a subchapter may be assigned to a chapter based upon determining a new temporal document associated with the chapter is indicative of an additional aspect of the chapter. That is, the new temporal document may be contextually and/or temporally associated with the chapter, but may discuss how a particular portion of the chapter further developed. In this way, the subchapter may be assigned to the chapter, and the new temporal document may be assigned to the subchapter. In one example, the first storyline may relate to general news stories associated with the Japan earthquake. A chapter within the first storyline may relate to rescue efforts associated with the Japan earthquake. A news story (e.g., a new temporal document) may discuss a particular survivor's story about being rescued from the rubble. The news story may relate to the chapter because it discusses rescue efforts, but the news story may discuss a particular development of a rescue case. Accordingly, a subchapter for the chapter may be created for survivor stories based upon the news story, and the news story may be assigned to the subchapter.

In another example, a branch may be created based upon one or more temporal documents associated with the main story, but not associated with the first storyline (e.g., but are associated with a second storyline of the main story). The branch may be created from the first storyline to a second storyline. The second storyline may be derived from document topics of the one or more temporal documents that are not associated with the first storyline. For example, a second set of chapters may be identified for the second storyline (e.g., a second chapter may be identified and a chapter topic may be assigned to the second chapter based upon one or more document topics indicative of the second chapter), and the one or more temporal documents may be assigned to chapters within the second set of chapters. In one example, a news story (e.g., a temporal document) may be temporally associated with a chapter within a first storyline corresponding to rescue efforts for the Japan earthquake. The news story may discuss reactions of foreign nations to the Japan earthquake. The news story may relate to the main story of the Japan earthquake, but may not relate to the first storyline corresponding to rescue efforts for the Japan earthquake. Accordingly, a second storyline associated with reactions of foreign nations to the earthquake may be created (e.g., a second set of chapters may be constructed for the second storyline). A branch may be created from the first storyline to the second storyline. The news story may be assigned to the second set of chapters within the second storyline. In this way, a user may be able to visually trace how the second storyline evolved from the first storyline.

Because topics of storylines may merge, a second branch from the second storyline to the first storyline may be created, thus merging the storylines at a particular point within the storyline visualization. For example, a new temporal document associated with the second storyline may be identified as comprising a document topic corresponding to a chapter topic of a chapter within the first storyline. For example, a news story (e.g., a new temporal document) may comprise a document topic of rescue efforts by foreign nations. The news story may be associated with the second storyline relating to reactions of foreign nations. Because the document topic of rescue efforts by foreign nations may be similar to a chapter topic (e.g., rescue efforts) of a chapter within the first storyline, a second branch may be created from the second storyline to the first storyline, and the news story may be assigned to the chapter within the first storyline. In one example of merging, the first storyline and the second storyline may be merged if a threshold number of documents (e.g., 90% or more) assigned to the second storyline are (e.g., sufficiently) context similar to documents assigned to the first storyline. In another example of merging, a cross reference may be created within the second storyline that cross references the first storyline if at least some of the documents (e.g., 50% or more) assigned to the second storyline are (e.g., sufficiently) context similar with documents assigned to the first storyline. In this way, the second branch from the second storyline to the first storyline may be created so that a user may be able to visually trace how the second storyline and the first storyline merged.

To aid a user in exploring the storyline visualization, chapter summaries may be created for chapters. A chapter summary of a chapter may comprise content extracted from one or more temporal documents assigned to the chapter. For example, the chapter summary may comprise a title, a date range, an abstract, an image, and/or other information descriptive of the chapter. In this way, the user may explore temporal documents organized into descriptive chapters, subchapters, and/or various storylines (e.g., through branches), which may allow the user to visualize the evolution of the main story. At 110, the method ends.

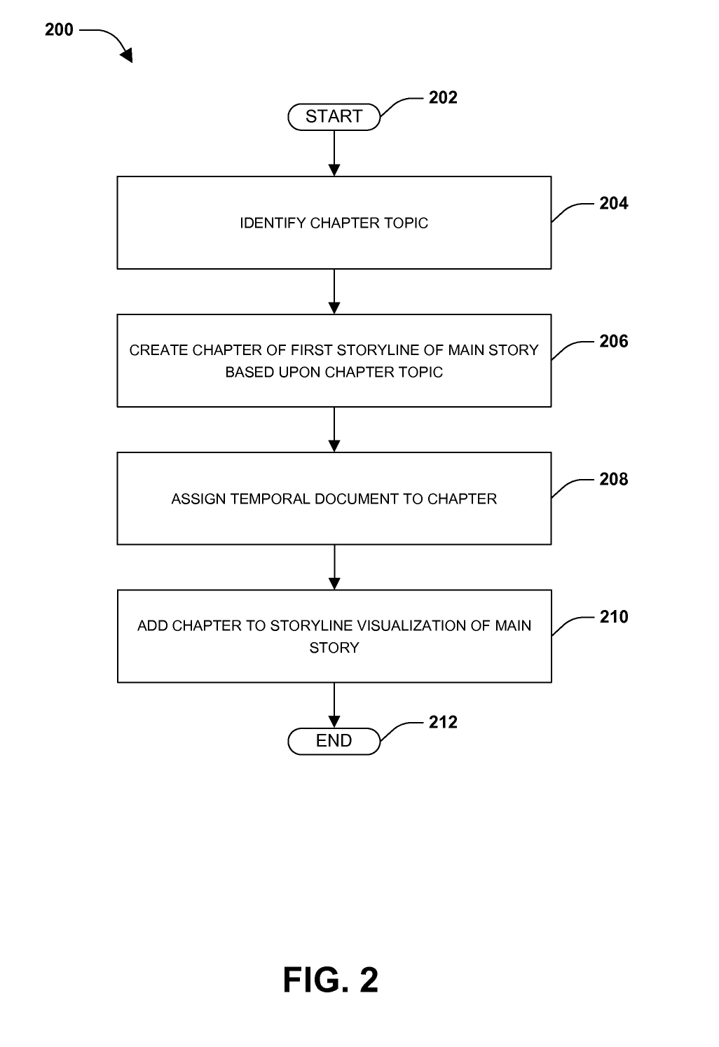

One embodiment of creating a storyline visualization is illustrated by an exemplary method 200 in FIG. 2. The storyline visualization may relate to a main story extracted from various temporal documents (e.g., data associated with a timestamp, such as news stories, blogs, social network posts, web pages, etc.). The temporal documents may comprise document topics describing content of the temporal documents. For example, a cluster analysis technique may have been performed upon the temporal documents to assign document topics to temporal documents and/or assign similar temporal documents to clusters of temporal documents. In this way, the temporal documents may be evaluated based upon document topics, clusters, and/or timestamps to identify groupings of content similar and/or temporally similar temporal documents that may be indicative of chapters of the main story discussed within such temporal documents.

At 202, the method starts. At 204, a chapter topic may be identified based upon one or more document topics and/or one or more timestamps associated with a cluster of temporal documents. For example, a cluster analysis technique may have been performed to cluster one or more related temporal documents into the cluster of temporal documents (e.g., content similar documents discussing similar topics and/or temporally similar documents comprising similar timestamps) and/or assign document topics to the respective temporal documents.

At 206, a chapter of a first storyline of a main story may be created based upon the chapter topic. That is, the temporal documents may generally relate to the main story (e.g., an earthquake in Japan). The main story may be associated with one or more storylines (e.g., rescue efforts, economic impact, reconstruction, etc.). A storyline may comprise one or more chapters. A chapter may be created based upon a chapter topic derived from one or more document topics of documents indicative of the chapter. In one example of creating a chapter, a chapter topic of initial news for the Japan earthquake may be created based upon a cluster of temporal documents comprising document topics relating to initial news of the earthquake that were published on 4/20. The chapter may be created based upon the chapter topic of initial news for the Japan earthquake, and may be assigned a date range of 4/20. In this way, the chapter of the first storyline may be created, and content similar (e.g., discussing initial news stories of the earthquake) and/or temporally similar (e.g., published on 4/20) temporal documents may be assigned to the chapter.

At 208, a temporal document may be assigned to the chapter based upon the temporal document comprising a timestamp within the date range of the chapter (e.g., the temporal document is temporally similar to the chapter) and/or a document topic corresponding to the chapter topic of the chapter (e.g., the temporal document is content similar to the chapter). In this way, the temporal document may be organized into the chapter. At 210, the chapter may be added to a storyline visualization of the main story. For example, the chapter may be added as part of the first storyline within the storyline visualization. Because other temporal documents may be indicative of other chapters within the first storyline, a set of chapters associated with the first storyline may be created and added to the first storyline within the storyline visualization.

Because additional aspects of the chapter may be discussed within a new temporal document associated with a chapter, a subchapter may be assigned to the chapter based upon determining the new temporal document is indicative of an additional aspect of the chapter. In this way, the subchapter may be assigned to the chapter within the storyline visualization, and the new temporal document and/or other temporal documents (e.g., content similar and/or temporally similar) may be assigned to the subchapter. In this way, a user may be able to explore the subchapter to understand how additional aspects of the chapter further developed.

Because the main story may branch into various storylines, branches between storylines may be created within the storyline visualization, which may allow a user to visually trace how various storylines evolved. In one example, a branch may be created from the first storyline to a second storyline based upon a second document topic of a second temporal document deviating from the first storyline above a threshold. That is, the second temporal document may be temporally similar to a chapter within the first storyline and content similar to the main story, but may be content dissimilar from the first storyline (e.g., the first storyline may be assigned chapters associated with rescue efforts for the Japan earthquake, while the second temporal document may discuss economic impact of the Japan earthquake). Accordingly, the branch may be created from the first storyline to the second storyline within the storyline visualization, and the second temporal document may be assigned to a second chapter of the second storyline (e.g., the second chapter may be created and/or assigned to the second storyline based upon the second document topic and/or a timestamp of the second temporal document).

If topics discussed within the second storyline merge with the first storyline, then a second branch may be created from the second storyline to the first storyline. For example, a third temporal document may be associated with the second storyline (e.g., temporally similar), and may be content similar to the main story. However, a third document topic of the third temporal document may deviate from the second storyline above a threshold. Instead of being content similar with the second storyline, the third temporal document may be content similar to the first storyline. Accordingly, the second branch may be created to merge the second storyline into the first storyline based upon the third document topic of the third temporal document deviating from the second storyline above the threshold, yet being content similar to the first storyline. That is, the second branch may be created from the second storyline to the first storyline within the storyline visualization, and the third temporal document may be assigned to a third chapter of the first storyline (e.g., the third chapter may be created and/or assigned to the first storyline based upon the third document topic and/or a timestamp of the third temporal document). In this way, a user may be able to visually trace how temporal documents of the main story are organized into chapters, subchapters, and/or storylines connected through branches. At 212, the method ends.

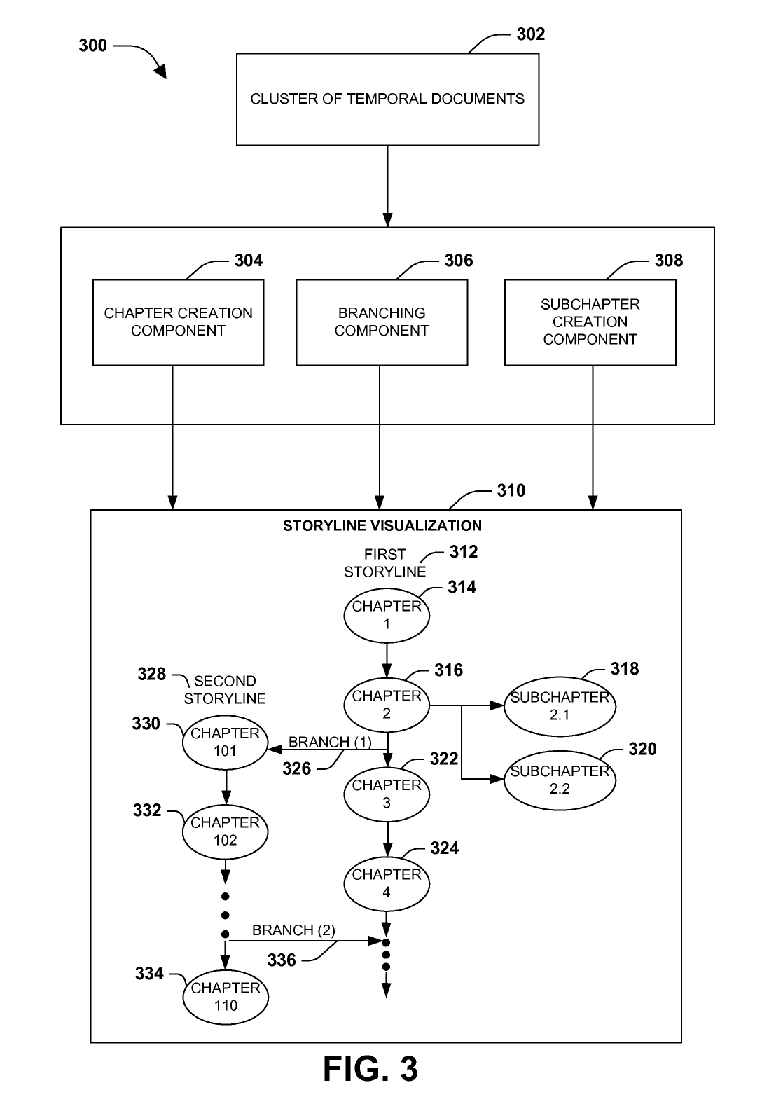

FIG. 3 illustrates an example of a system 300 configured to create a storyline visualization 310. The system 300 may be configured to create the storyline visualization 310 based upon one or more clusters of temporal documents (e.g., a cluster of temporal documents 302, which may have been clustered based upon a cluster analysis technique used to cluster content similar and/or temporally similar temporal documents). The system 300 may comprise a chapter creation component 304, a branching component 306, and/or a subchapter creation component 308. The chapter creation component 304 may be configured to create one or more chapters within the storyline visualization 310 (e.g., chapter (1) 314, chapter (2) 316, chapter (3) 322, chapter (4) 324, chapter (101) 330, chapter (102) 332, chapter (110) 334, and/or other chapters not illustrated), and may assign content similar and/or temporally similar documents to respective chapters (e.g., news stories regarding rescue efforts for the Japan earthquake that were published between 4/23 and 4/25 may be assigned to a particular chapter associated with a chapter topic of earthquake rescue efforts and a date range 4/23 to 4/25).

In one example of creating a chapter, the chapter creation component 304 may identify a chapter topic based upon one or more document topics and/or one or more timestamps associated with the cluster of temporal documents 302. For example, a chapter topic of earthquake rescue efforts may be identified based upon temporal documents within the cluster of temporal documents 302 being associated with document topics regarding rescue efforts for the earthquake. The chapter creation component 304 may create a chapter (e.g., chapter (3) 322) of a first storyline (e.g., first storyline 312) based upon the chapter topic. In one example, the chapter creation component 304 may assign the chapter topic to the chapter so that temporal documents that are content similar (e.g., temporal documents assigned document topics related to the chapter topic) may be assigned to the chapter. In another example, the chapter creation component 304 may assign a date range to the chapter so that temporal documents that are temporally similar may be assigned to the chapter. In this way, the chapter creation component 304 may assign a temporal document to the chapter based upon the temporal document comprising a timestamp within the date range of the chapter and a document topic corresponding to the chapter topic of the chapter. The chapter creation component 304 may assign the chapter to the storyline visualization 310. To aid a user in exploring the storyline visualization 310, the chapter creation component 304 may create a chapter summary for the chapter. The chapter summary may comprise a title, a date range, an abstract, an image, and/or other information illustrate of the chapter.

The subchapter creation component 308 may be configured to assign subchapters to chapters within the storyline visualization 310. For example, the subchapter creation component 308 may assign subchapter to a chapter (e.g., subchapter (2.1) 318 and/or subchapter (2.2) 320 may be assigned to chapter (2) 316) based upon determining a new temporal document associated with the chapter is indicative of an additional aspect of the chapter. The new temporal document may be assigned to the subchapter. For example, chapter (2) 316 may be assigned a chapter topic of casualty reports, and thus may be assigned temporal documents discussing casualty reports. A news story may discuss a particular family's story of losing a family member to the earthquake. Because the family's story may be an additional aspect of the casualty reports, the subchapter (2.1) 318 may be created, and the news story may be assigned to the subchapter (2.1) 318.

The branching component 306 may be configured to create branches between storylines within the storyline visualization 310 (e.g., branch (1) 326 connecting the first storyline 312 to a second storyline 328, a branch (2) 336 connecting the second storyline 328 to the first storyline 312, etc.). In one example, the branching component 306 may create the branch (1) 326 from the first storyline 312 to the second storyline 328 based upon a second temporal document deviating from the first storyline 312 above a threshold. That is, the second temporal document may be temporally similar to a chapter within the first storyline (e.g., chapter (2) 316) and content similar to the main story, but may be content dissimilar from the first storyline 312 and/or chapter (2) 316. Accordingly, the branch (1) 326 may be created from the first storyline 312 to the second storyline 328 within the storyline visualization 310, and the second temporal document may be assigned to a second chapter of the second storyline 328 (e.g., chapter (101) 330).

The branch component 306 may be configured to create a branch merging two storylines. In one example, the branching component 306 may create the branch (2) 336 from the second storyline 328 to the first storyline 312 based upon a third document topic of a third temporal document deviating from the second storyline 328 above a threshold. That is, the third temporal document may be associated with the second storyline 328 (e.g., temporally similar), and may be content similar to the main story. However, the third document topic of the third temporal document may deviate from the second storyline 328 above the threshold. Instead of being content similar to the second storyline 328, the third temporal document may be content similar to the first storyline 312. Accordingly, the branch (2) 336 may be created to merge the second storyline 328 with the first storyline 312 based upon the third document topic of the third temporal document deviating from the second storyline 328 above the threshold, yet being content similar to the first storyline 312. Accordingly, the branch (2) 336 may be created from the second storyline 328 to the first storyline 312 within the storyline visualization 310, and the third temporal document may be assigned to a third chapter of the first storyline (e.g., chapter (5) not illustrated). In this way, a user may be able to visually trace how temporal documents of the main story are organized into chapters, subchapters, and/or storylines connected through branches. In one example, when such merging occurs all or substantially all documents are contextually similar (e.g., so that few to no documents relate to merely the first storyline 312 or to merely the second storyline 328).

In one example, the storyline visualization 310 may be created based upon clusters of news stories relating to an earthquake in Japan. Chapter (1) 314 may be created based upon news stories discussing initial news of the earthquake that were published on 4/20. Once created, content similar (e.g., news stories relating to initial news of the earthquake) and/or temporally similar (e.g., news stories with a 4/20 publication date) news stories may be assigned to chapter (1) 314. Chapter (1) 314 may be used as a starting point to create the first storyline 312 (e.g., a storyline discussing events directly correlating to the Japan earthquake). Because other news articles may be indicative of other chapters within the first storyline 312, other chapters may be created within the first storyline 312. For example, chapter (2) 316 may be created based upon news stories discussing reported casualties of the earthquake that were published on 4/21. Once created, content similar (e.g., news stories relating to casualty reports) and/or temporally similar (e.g., news stories with a 4/21 publication date) news stories may be assigned to chapter (2) 316. In this way, chapter (3) 322, chapter (4) 324 and/or other chapters not illustrated may be created for the first storyline 312.

Subchapter (2.1) 318 and subchapter (2.2) 320 may be created for chapter (2) 316 based upon news stories that discuss additional aspects of chapter (2) 316 (e.g., additional aspects relating to casualty reports). For example, one or more news stories may discuss a particular family's story of losing a family member in the earthquake. Because the family's story may be an additional aspect of the casualty reports, the subchapter (2.1) 318 may be created, and the one or more news stories may be assigned to the subchapter (2.1) 318.

Branch (1) 326 may be created from the first storyline 312 to the second storyline 328 based upon one or more news stories discussing reactions of foreign nations to the devastation from the Japan earthquake, for example. Because the reactions of foreign nations are not content similar with the casualty reports being discussed within chapter (2) 316 of the first storyline 312, the branch (1) 326 may be created to the second storyline 328. The chapter (101) 330 may be created based upon the one or more news stories discussing the reactions of foreign nations, and one or more news stories may be assigned to chapter (101) 330. In this way, the second storyline 328 may be created based upon the chapter (101) 330 branching away from the first storyline 312. Chapter (102) 332, chapter (110) 334, and/or other chapters not illustrated may be created for the second storyline 328. Similarly, branch (2) 336 may be created from the second storyline 328 to the first storyline 312.

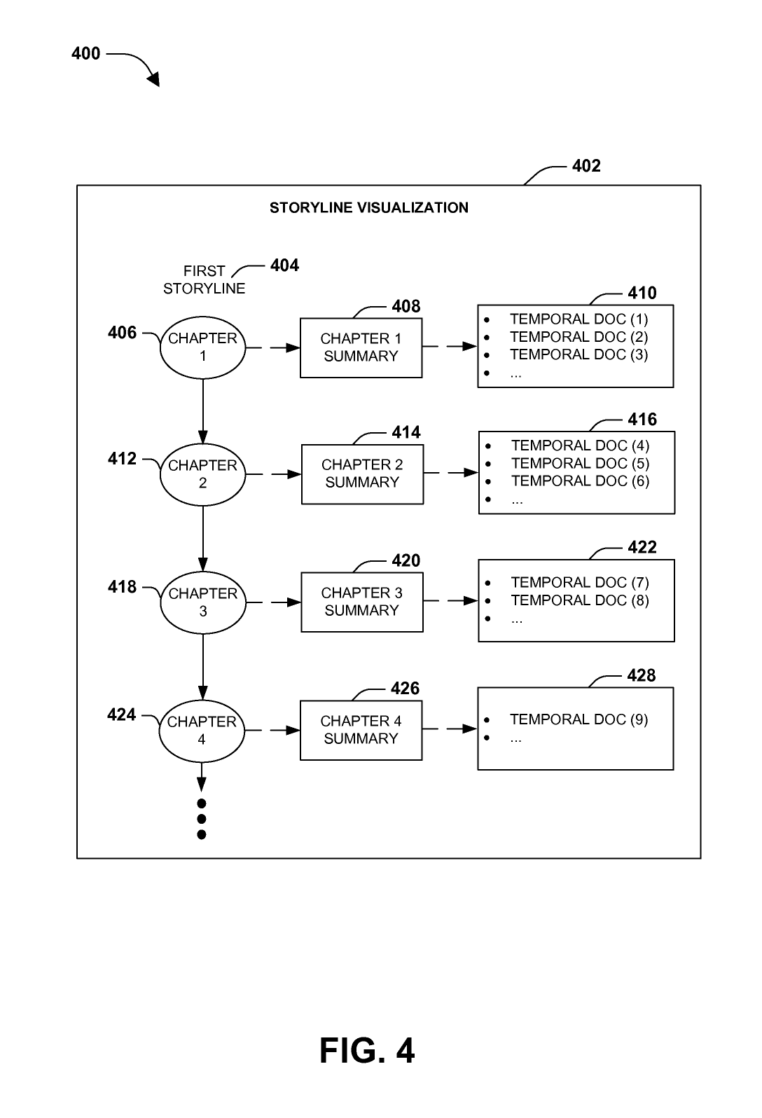

FIG. 4 illustrates an example 400 of a storyline visualization 402. The storyline visualization 402 may comprise a first storyline 404 (e.g., events associated with an earthquake in Japan) and/or other storylines (e.g., events associated with reactions of foreign nations to the earthquake in Japan) not illustrated. The first storyline 404 may be assigned a set of chapters, such as chapter (1) 406, chapter (2) 412, chapter (3) 418, chapter (4) 424, and/or other chapters not illustrated. Chapter (1) 406 may be assigned a chapter topic of initial news on the Japan earthquake and a date range of 4/20, chapter (2) 412 may be assigned a chapter topic of casualty reports for the Japan earthquake and a date range of 4/21, chapter (3) 418 may be assigned a chapter topic of rescue efforts for the Japan earthquake and a date range of 4/23 to 4/25, and chapter (4) 424 may be assigned a chapter topic of individuals missing from the Japan earthquake weeks later and a date range of 5/5 to 5/9, for example.

Temporal documents that are content similar and/or temporally similar to a chapter may be assigned to the chapter. That is, temporal documents that discuss topics similar to a chapter topic of a chapter may be considered content similar (e.g., a document topic of a temporal document may be indicative of a chapter topic of a chapter), and temporal documents having timestamps similar to a date range of a chapter may be considered temporally similar. For example, temporal documents 410 may be assigned to chapter (1) 406 because the temporal documents 410 may have publication dates of 4/20 and/or may be assigned document topics indicative of initial Japan earthquake news. Temporal documents 416 may be assigned to chapter (2) 412 because the temporal documents 416 may have publication dates of 4/21 and/or may be assigned document topics indicative of Japan earthquake causalities. Temporal documents 422 may be assigned to chapter (3) 418 because the temporal documents 422 may have publication dates between 4/23 and 4/25 and/or may be assigned document topics indicative of Japan earthquake rescue efforts. Temporal documents 428 may be assigned to chapter (4) because the temporal documents 428 may have publication dates between 5/5 and 5/9 and/or may be assigned document topics indicative of missing individuals from the Japan earthquake. In this way, a user may visually explore temporal documents organized into chapters of the first storyline 404.

To aid the user in exploring the storyline visualization 402, chapter summaries may be created for the chapters. For example, chapter (1) summary 408 may be created for chapter (1) 406, chapter (2) summary 414 may be created for chapter (2) 412, chapter (3) summary 420 may be created for chapter (3) 418, and/or chapter (4) summary 426 may be created for chapter (4) 424. A chapter summary may comprise a title, a date range, an abstract, an image, and/or other information relating to the chapter and/or temporal documents assigned to the chapter.

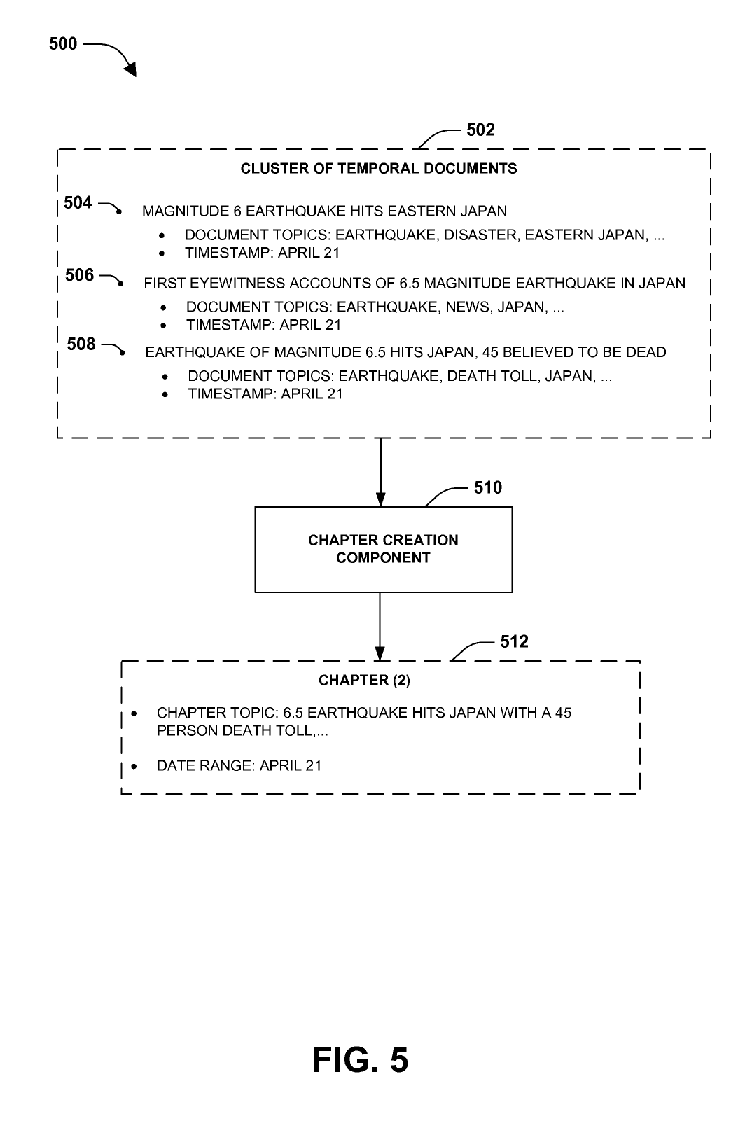

FIG. 5 illustrates an example of creating a chapter for a storyline visualization. A chapter creation component 510 may be configured to evaluate a cluster of temporal documents 502 to create a chapter, such as chapter (2) 512. In one example, the cluster of temporal documents 502 may comprise similar news documents clustered together by a cluster analysis technique. The news documents may have been assigned topics by the cluster analysis technique and/or by other means. The news documents may comprise timestamps specifying publication dates of the news documents.

The chapter creation component 510 may create chapter (2) 512 based upon a first news document 504, a second news document 506, a third news document 508, and/or other news document not illustrated. The first news document 504 may have been assigned document topics, such as earthquake, disaster, eastern Japan, etc. The second news document 506 may have been assigned document topics, such as earthquake, news, Japan, etc. The third news document 508 may have been assigned document topics, such as earthquake, death toll, Japan, etc. The chapter creation component 510 may assign a chapter topic of 6.5 earthquake hits Japan with a 45 person death toll to the chapter (2) 512 based upon the document topics assigned to the first, second, and/or third news documents. A date range of April 21^{st} may be assigned to the chapter (2) 512 based upon timestamps of the first, second, and/or third news documents. In this way, the chapter (2) 512 may be created, and the first news document 504, the second news document 506, the third news document 508, and/or other content similar and/or temporally similar news documents may be assigned to the chapter (2) 512.

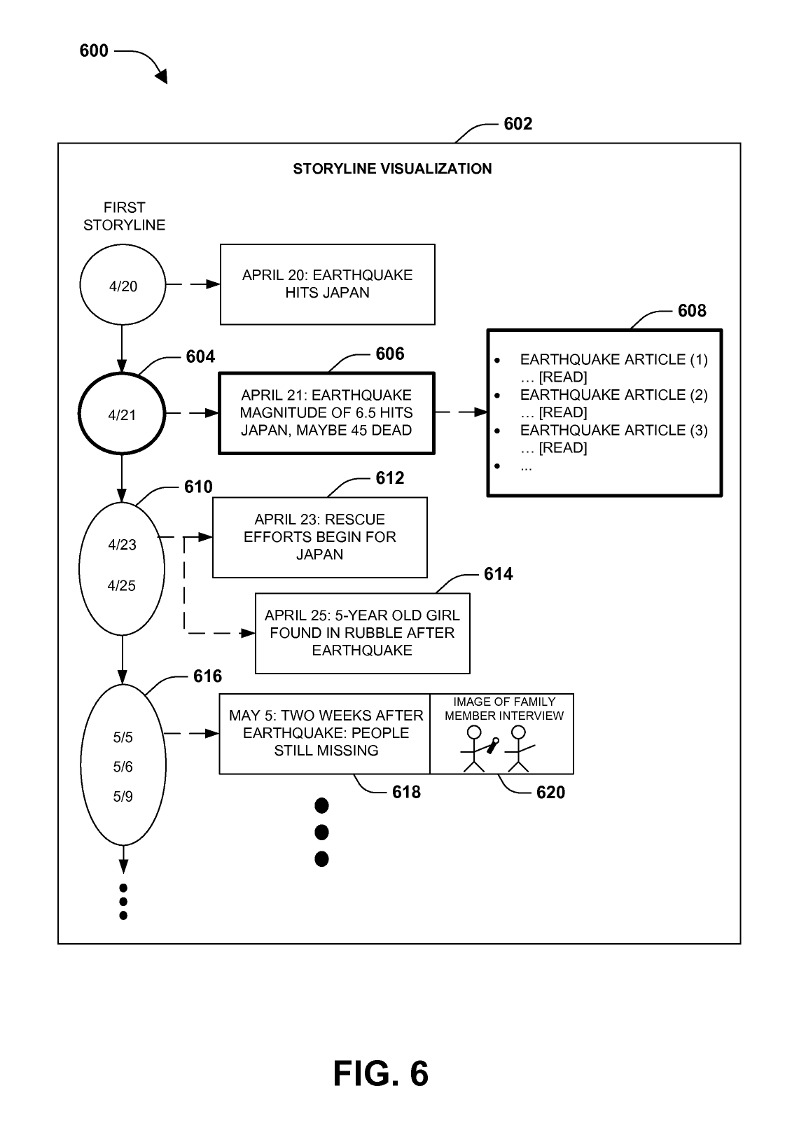

FIG. 6 illustrates an example 600 of a storyline visualization 602. The storyline visualization 602 may be presented to a user (e.g., within a web page, within a user interface application, etc.) so that the user may visually explore a main story (e.g., the Japan earthquake) represented by temporal documents (e.g., news stories) organized into chapters, subchapters, and/or storylines interconnected by branches. The storyline visualization 602 may provide an interactive experience for the user. For example, in response to a user selecting the first storyline, a set of chapters assigned to the first storyline may be presented. If the user selects a chapter, such as chapter 604, then a chapter summary 606 of the chapter 604 may be presented. The chapter summary 606 may comprise a title of “Earthquake magnitude of 6.5 hits Japan, maybe 45 dead”, a date range of April 21, and/or other information not illustrated (e.g., chapter summary 618 of chapter 616 may comprise an image 620). If the user selects the chapter summary 606, then a set of news stories 608 assigned to the chapter 604 may be presented. The set of news stories 608 may allow the user to quickly locate and/or read news stories assigned to chapter 604.

The storyline visualization 602 may comprise subchapters that are assigned to chapters. For example, chapter 610 (e.g., relating to rescue efforts as described in the chapter summary 612 of the chapter 610) may comprise a subchapter (e.g., relating to a particular story of a 5 year old girl rescued after the earthquake as described in a chapter summary 614 of the subchapter). If the user selects the chapter 610, then the chapter summary 612 of the chapter 610 and/or the chapter summary 614 of the subchapter may be presented to the user.

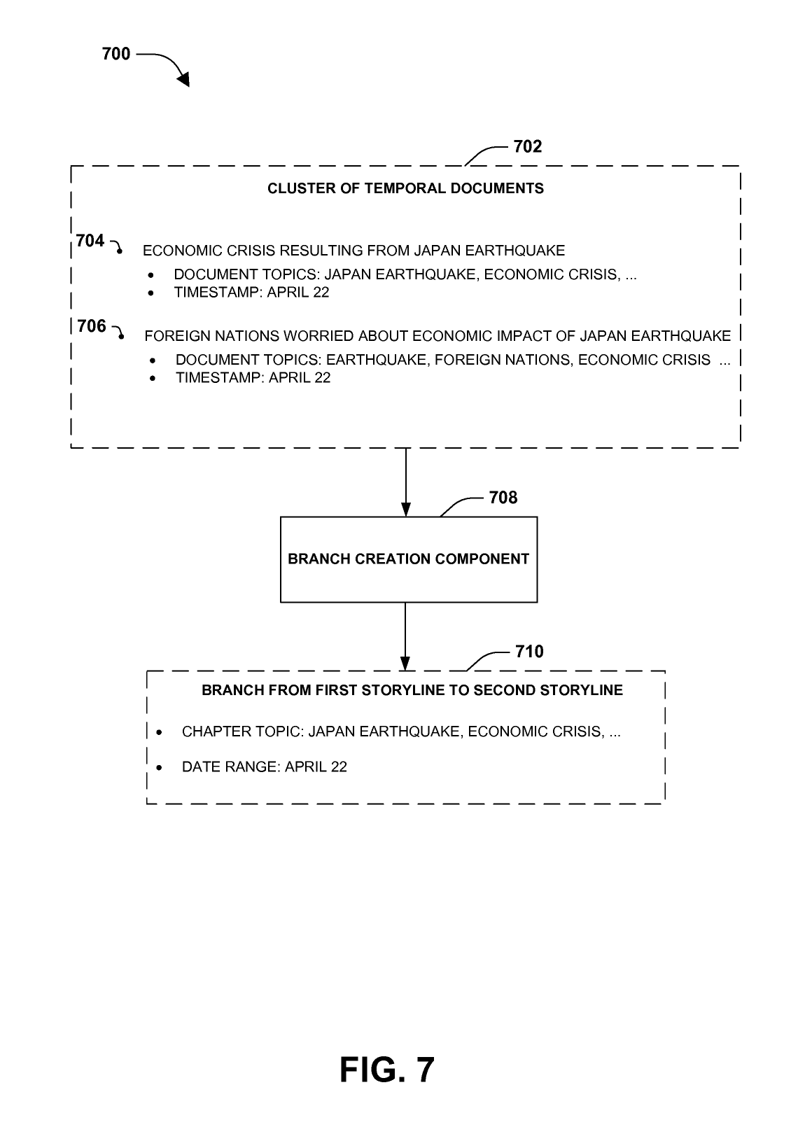

FIG. 7 illustrates an example 700 of creating a branch for a storyline visualization. A branch creation component 708 may be configured to evaluate a cluster of temporal documents 702 to create a branch, such as a branch 710 from a first storyline to a second storyline within the storyline visualization. In one example, the cluster of temporal documents 702 may comprise similar news documents clustered together by a cluster analysis technique (e.g., news stories relating to an earthquake in Japan). The cluster analysis technique may have assigned document topics to the respective news documents. The news documents may comprise timestamps specifying publication, creation, etc. dates of the news documents, for example.

The branch creation component 708 may determine that a news document 704 and/or a news document 706 comprise document topics that deviate from the first storyline above a threshold. For example, the first storyline may relate to initial news, casualties, and rescue efforts associated with the Japan earthquake. However, the news document 704 and/or the news document 706 may comprise document topics of foreign nations, economic crisis, foreign aid to Japan, etc. Accordingly, the branch creation component 708 may create the branch 710 from the first storyline to the second storyline. The second storyline and/or chapters therein may be created based upon the news document 704 and/or the news document 706. In this way, the news document 704, the news document 706, and/or other news documents that are content similar (e.g., relating to Japan earthquake, economic crisis, foreign nations, etc.) and/or temporally similar may be assigned to one or more chapters within the second storyline.

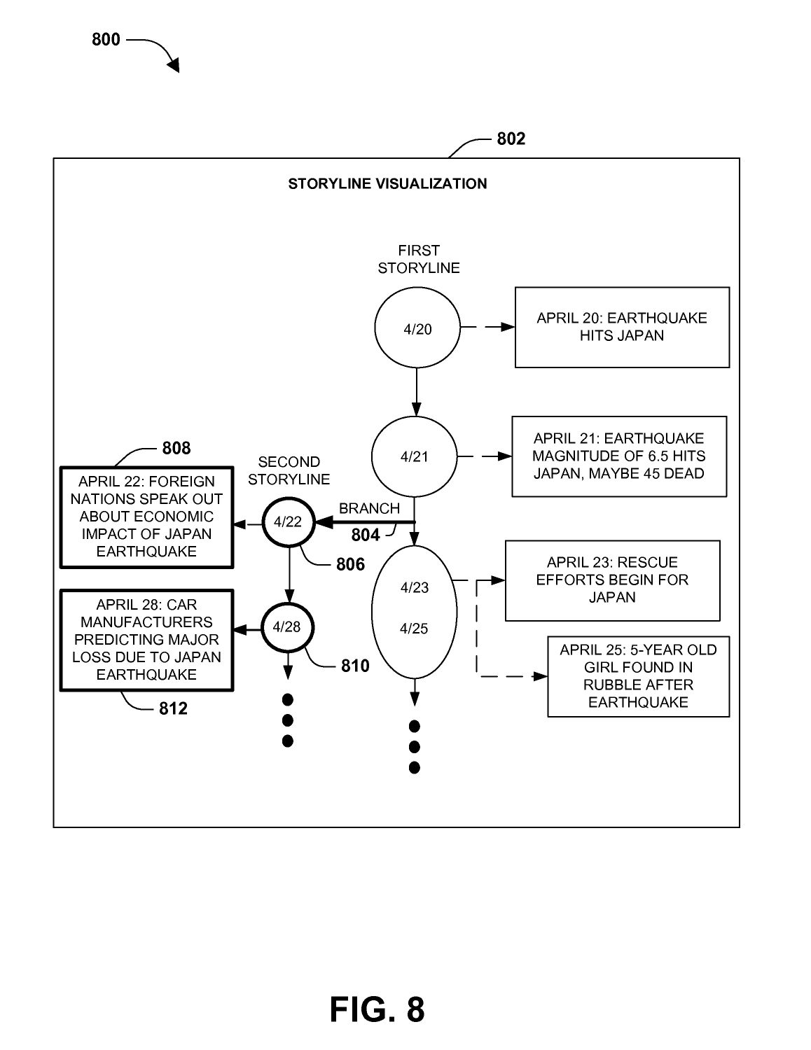

FIG. 8 illustrates an example 800 of a storyline visualization 802 comprising a branch 804 from a first storyline to a second storyline. The first storyline may comprise a first chapter associated with news documents on 4/20 discussing initial news of the earthquake hitting Japan, a second chapter associated with news documents on 4/21 discussing the magnitude and casualties of the earthquake, and/or other chapters. A new news story discussing foreign nations speaking about the economic impact of the Japan earthquake may be temporally associated with the first storyline (e.g., 4/22), but may not be contextually related to the first storyline (e.g., economic impact and/or reactions of foreign nations may not be content similar to the magnitude and casualties of the earthquake, at least relative to a content similar threshold). Accordingly, the branch 804 may be created from the first storyline to the second storyline. The new news story may be used to create the second storyline and/or a chapter 806 within the second storyline 806 to which the new news story may be assigned. Other chapters may be created for the second storyline, such as chapter 810, based upon other news stories that are content similar and/or temporally similar to the second storyline. Chapter summaries 808 and/or 812 may be presented for the chapters 806 and 810 within the second storyline. In this way, the user may visually explore the storyline visualization 802 to understand how the second storyline evolved from the first storyline.

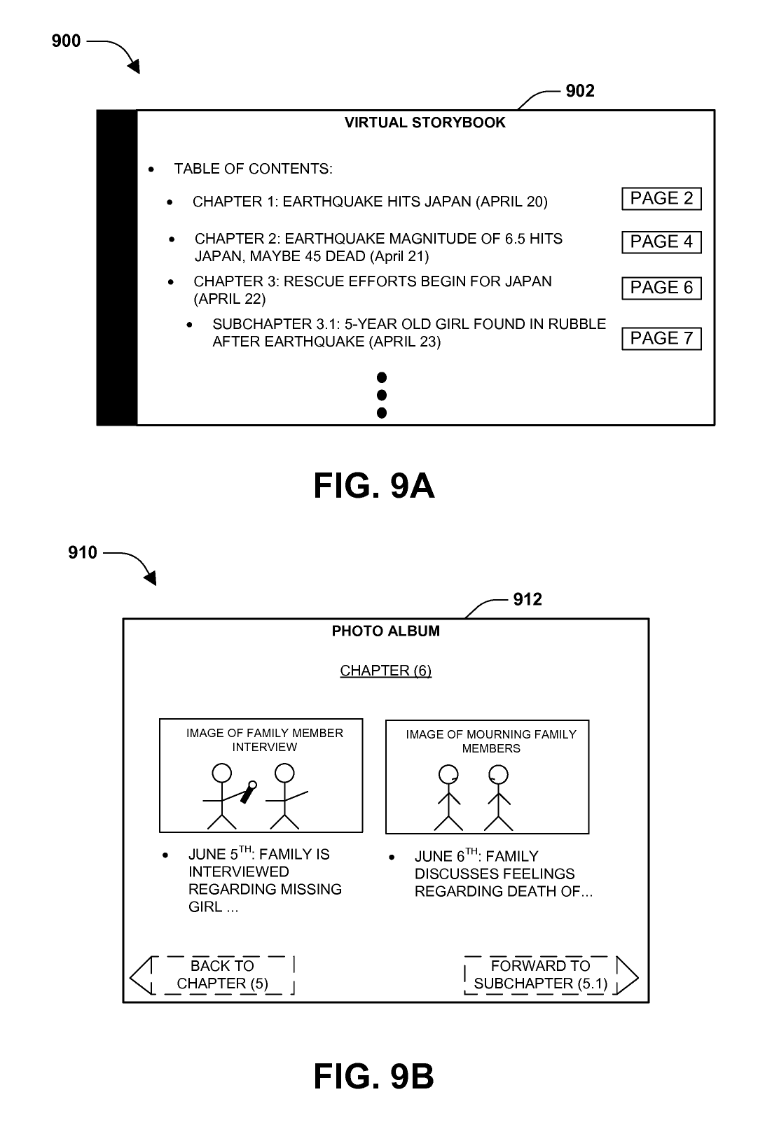

FIG. 9A illustrates an example 900 of a storyline visualization implemented as a virtual storybook 902. The storyline visualization may organize temporal documents into chapters, subchapters, and/or various storylines interconnected by branches. To aid the user in exploring the temporal documents, the storyline visualization may be presented as the virtual storybook 902. The virtual storybook 902 may comprise a table of contents that may provide the user with a brief overview of chapters, subchapters, and/or chapter summaries. The user may be able to click on links to pages within the virtual storybook 902 comprising particular chapters and/or subchapters interesting to the user, which may additionally lead to temporal documents that the user may read. In this way, the user may explore and/or interact with the virtual storybook 902.

FIG. 9B illustrates an example 910 of a storyline visualization implemented as a photo album 912. The storyline visualization may organize temporal documents into chapters, subchapters, and/or various storylines interconnected by branches. To aid the user in exploring the temporal documents, the storyline visualization may be presented as the photo album 912. The photo album 912 may sequentially present chapter summaries of chapters (e.g., an image and textual abstract summarizing temporal documents assigned to a chapter), which may allow a user to further explore temporal documents assigned to such chapters. In this way, the user may explore and/or interact with the photo album 912.

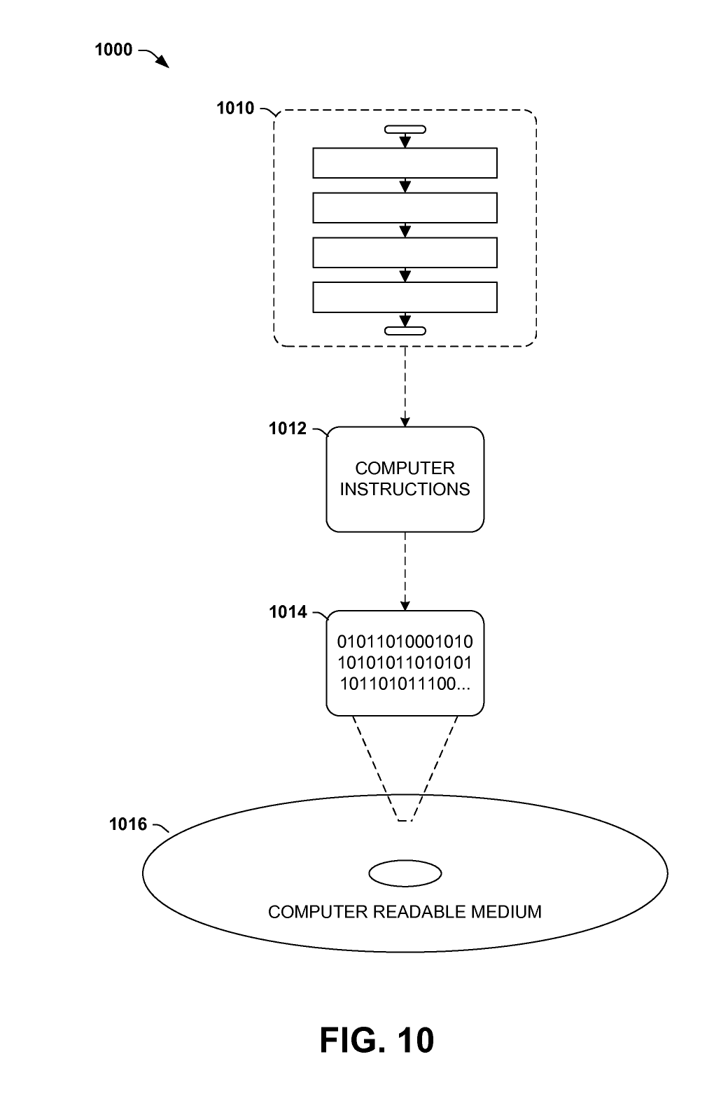

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1016 (e.g., a CD-R, DVD-R, or a platter of a hard disk drive), on which is encoded computer-readable data 1014. This computer-readable data 1014 in turn comprises a set of computer instructions 1012 configured to operate according to one or more of the principles set forth herein. In one such embodiment 1000, the processor-executable computer instructions 1012 may be configured to perform a method 1010, such as at least some of the exemplary method 100 of FIG. 1 and/or at least some of the exemplary method 200 of FIG. 2, for example. In another such embodiment, the processor-executable instructions 1012 may be configured to implement a system, such as at least some of the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

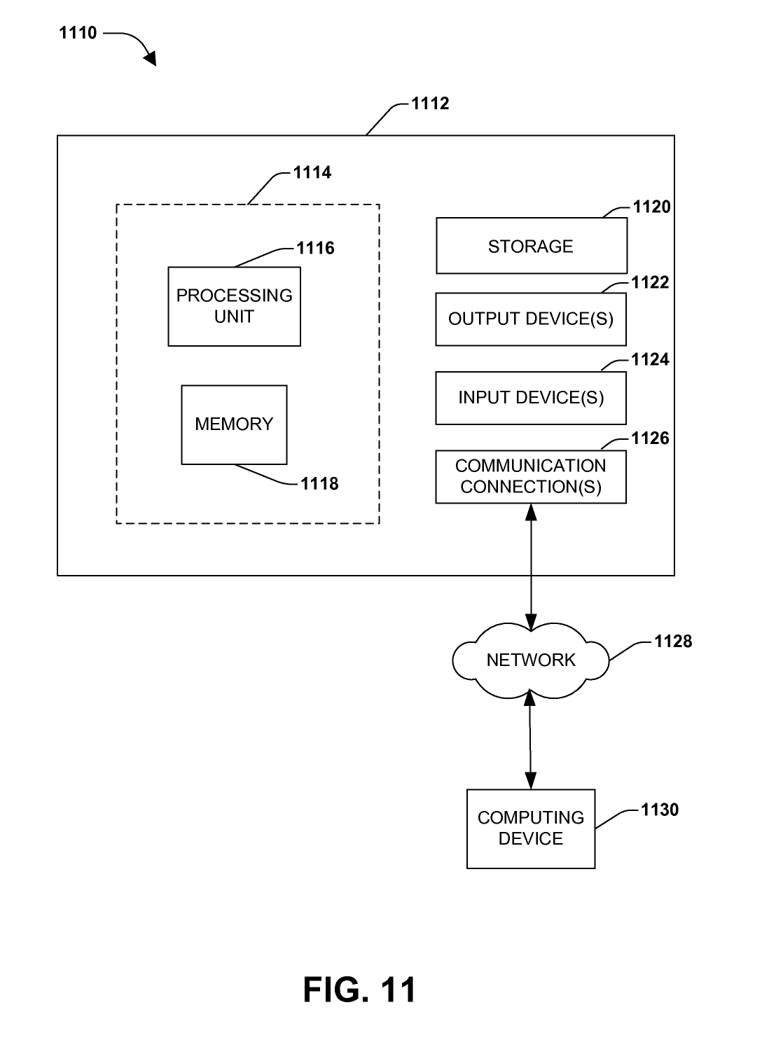

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 13114), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for creating a storyline visualization, comprising:
identifying a set of chapters associated with a first storyline of a main story based upon a cluster analysis of temporal documents, the identifying comprising assigning a chapter topic to a chapter based upon document topics of temporal documents indicative of the chapter;
for respective temporal documents, assigning a current temporal document to a current chapter based upon a document topic of the current temporal document corresponding to a current chapter topic of the current chapter; and
constructing a storyline visualization of the main story using the set of chapters.

2. The method of claim 1, the identifying a set of chapters comprising:
assigning a date range to the chapter based upon timestamps of the temporal documents.

3. The method of claim 2, the assigning a current temporal document comprising:
assigning the current temporal document based upon a timestamp of the current temporal document corresponding to a date range of the current chapter.

4. The method of claim 1, comprising:
determining that one or more temporal documents associated with the main story are not associated with the first storyline;
creating a branch within the storyline visualization from the first storyline to a second storyline derived from document topics of the one or more temporal documents that are not associated with the first storyline, the branch comprising a second set of chapters associated with the second storyline; and
assigning the one or more temporal documents that are not associated with the first storyline to the second set of chapters within the storyline visualization.

5. The method of claim 4, comprising:
determining a new temporal document associated with the second set of chapters comprises a document topic corresponding to a chapter topic of a chapter within the set of chapters; and
creating a second branch within the storyline visualization, the second branch connecting the second storyline to the first storyline based upon the new temporal document.

6. The method of claim 1, a temporal document comprising at least one of data associated with a timestamp, a news article, a web page, a social network post, a blog, a microblog, and a document.

7. The method of claim 1, the storyline visualization comprising at least one of a virtual storybook, a timeline, a photo album, a slideshow, and a tree structure.

8. The method of claim 1, comprising:
assigning a subchapter to the chapter based upon determining a new temporal document associated with the chapter is indicative of an additional aspect of the chapter; and
assigning the new temporal document to the subchapter.

9. The method of claim 1, comprising:
creating a chapter summary for the chapter, the chapter summary comprising at least one of a title, a date range, an abstract, and an image.

10. A method for creating a storyline visualization, comprising:
identifying a chapter topic based upon one or more document topics and one or more timestamps associated with a cluster of temporal documents;
creating a chapter of a first storyline of a main story based upon the chapter topic, the creating comprising assigning a date range to the chapter based upon the one or more timestamps;
assigning a temporal document to the chapter based upon the temporal document comprising a timestamp within the date range of the chapter and a document topic corresponding to the chapter topic of the chapter; and
adding the chapter to a storyline visualization of the main story.

11. The method of claim 10, comprising:
creating a set of chapters associated with the first storyline; and
adding the set of chapters to the first storyline within the storyline visualization.

12. The method of claim 10, comprising:
creating a branch from the first storyline to a second storyline based upon a second document topic of a second temporal document deviating from the first storyline above a threshold, the second temporal document associated with the main story; and
assigning the second temporal document to a second chapter of the second storyline.

13. The method of claim 12, comprising:
creating a second branch from the second storyline to the first storyline based upon a third document topic of a third temporal document deviating from the second storyline above a threshold, the third temporal document associated with the first storyline; and
assigning the third temporal document to a third chapter of the first storyline.

14. The method of claim 10, comprising:
assigning a subchapter to the chapter based upon determining a new temporal document associated with the chapter is indicative of an additional aspect of the chapter; and
assigning the new temporal document to the subchapter.

15. A system for creating a storyline visualization, comprising:
a chapter creation component configured to:
identify a chapter topic based upon one or more document topics and one or more timestamps associated with a cluster of temporal documents;
create a chapter of a first storyline of a main story based upon the chapter topic, the creating comprising assigning a date range to the chapter based upon the one or more timestamps;
assign a temporal document to the chapter based upon the temporal document comprising a timestamp within the date range of the chapter and a document topic corresponding to the chapter topic of the chapter; and
add the chapter to a storyline visualization of the main story.

16. The system of claim 15, comprising:
a branching component configured to:
create a branch from the first storyline to a second storyline based upon a second document topic of a second temporal document deviating from the first storyline above a threshold, the second temporal document associated with the main story; and
assign the second temporal document to a second chapter of the second storyline.

17. The system of claim 16, the branching component configured to:
create a second branch from the second storyline to the first storyline based upon a third document topic of a third temporal document deviating from the second storyline above a threshold, the third temporal document associated with the first storyline; and
assign the third temporal document to a third chapter of the first storyline.

18. The system of claim 15, comprising:
a subchapter creation component configured to:
assign a subchapter to the chapter based upon determining a new temporal document associated with the chapter is indicative of an additional aspect of the chapter; and
assign the new temporal document to the subchapter.

19. The system of claim 15, the chapter creation component configured to:
create a chapter summary for the chapter, the chapter summary comprising at least one of a title, a date range, an abstract, and an image.

20. The system of claim 15, the storyline visualization comprising at least one of a virtual storybook, a timeline, a photo album, a slideshow, and a tree structure.
